(19) United States
(12) Patent Application Publication
(10) Pub. No.: US 2018/0035691 A1
(43) Pub. Date: Feb. 8, 2018

(54) HIGHLY STABLE AERATED OIL-IN-WATER EMULSION

(71) Applicant: CSM Bakery Solutions Europe Holding B.V., Amsterdam (NL)

(72) Inventors: William Michael HESLER, Lilburn, GA (US); Orelia Elizabeth DANN, Decatur, GA (US); Andrew Richard HART, Dunwoody, GA (US)

(73) Assignee: CSM Bakery Solutions Europe Holding B.V., Amsterdam (NL)

(21) Appl. No.: 15/669,060

(22) Filed: Aug. 4, 2017

Related U.S. Application Data
(60) Provisional application No. 62/371,488, filed on Aug. 5, 2016.

(51) Int. Cl. A23G 9/46; A23D 7/005

(52) U.S. Cl. CPC A23G 9/46; A23D 7/0053

(57) ABSTRACT

The invention relates to an oil-in-water (O/W) emulsions that can be aerated to produce foamed emulsions. More particularly, the invention relates to an aeratable or aerated O/W emulsion comprising a continuous aqueous phase and a dispersed oil phase, said emulsion containing:
25-55 wt. % water;
4-50 wt. % oil;
3-12 wt. % of cyclodextrin selected from alpha-cyclodextrin, beta-cyclodextrin and combinations thereof;
20-60 wt. % of saccharides selected from monosaccharides, disaccharides, non-cyclic oligosaccharides, sugar alcohols and combinations thereof;
1-20 wt. % of polysaccharides;
0-30 wt. % of other edible ingredients;
   wherein the saccharides are contained in the emulsion in a concentration of at least 60% by weight of water and wherein the polysaccharides are contained in the emulsion in a concentration at least 2% by weight of water.

The O/W emulsions are capable of forming foamed emulsions with high firmness and excellent shape retaining properties. These foamed emulsions further offer the advantage that they exhibit excellent stability.

### CROSS-REFERENCE TO RELATED APPLICATIONS

This non-provisional application claims the benefit of priority to U.S. Provisional Application No. 62/371,488, filed Aug. 5, 2016. The contents of the priority application are herein incorporated by reference in their entirety.

### TECHNICAL FIELD OF THE INVENTION

The present invention relates to highly stable aerated oil-in-water (O/W) emulsions. More particularly the invention provides aerated O/W emulsions that can be applied as, for instance, toppings or fillings. The invention further relates to non-aerated O/W emulsions that can be aerated to form the aforementioned highly stable aerated O/W emulsion.

The aeratable or aerated oil-in-water emulsion of the present invention comprises a continuous aqueous phase and a dispersed oil phase, said emulsion containing:
25-55 wt. % water;
4-50 wt. % oil;
3-12 wt. % of cyclodextrin selected from alpha-cyclodextrin, beta-cyclodextrin and combinations thereof;
20-60 wt. % of saccharides selected from monosaccharides, disaccharides, non-cyclic oligosaccharides, sugar alcohols and combinations thereof;
1-20 wt. % of polysaccharides;
0-30 wt. % of other edible ingredients;
   wherein the saccharides are contained in the emulsion in a concentration of at least 60% by weight of water and wherein the polysaccharides are contained in the emulsion in a concentration at least 2% by weight of water.

The aerated emulsions of the present invention are very stable under ambient conditions and can withstand elevated temperatures.

The invention further relates to an aeratable O/W emulsions that can be whipped or otherwise aerated to yield a highly stable foam.

### BACKGROUND OF THE INVENTION

Aerated O/W emulsions are commonly used as toppings and fillings for various kinds of cakes and pies, as well as for a variety of other foodstuffs. Aerated O/W emulsion are usually prepared by introducing air or other gas into an aeratable O/W emulsion with fluid characteristics. The aeratable O/W emulsion typically comprises water, liquid oil, solid fat, sugars and protein. Typically the air/gas is mechanically mixed (e.g. whipped) into the emulsion in a manner that creates a dispersion of very fine gas bubbles. These bubbles have to be stabilized in order to allow the O/W emulsion to form a voluminous foam upon aeration and further to prevent the foam from collapsing.

Aeration and the introduction of air/gas initially destabilize O/W emulsions, because agitation favors the coalescence of fat globules. Aeration of creams yields a foam that comprises a continuous aqueous phase, dispersed gas bubbles and partially coalesced fat globules. In aerated creams the air-water interface is stabilized by partially coalesced fat globules that are held together by fat crystals.

During aeration of creams partial coalescence of fat globules and association with fat crystals yields a rigid network in which air bubbles as well as liquid (water phase and oil phase) are entrapped. This network also prevents further coalescence of the fat globules into bigger fat globules that are no longer capable of structure-building and that would cause the foam to collapse. Fat crystals break and penetrate the interfacial layer around the fat globules in the emulsion, allowing fat globules to clump together into the network.

Coalescence of fat globules during and after aeration is influenced by the type and amount of emulsifier in the O/W emulsion. Proteins, for example, can reduce the susceptibility of fat globules to coalesce by forming a layer around the fat globules, which increases the repulsive forces and the resistance to penetration of the fat globules by fat crystals.

In many aeratable O/W emulsions the presence of solid fat is a crucial factor for stabilization of the aerated emulsions. This is evident from the fact that aearated emulsions that are stabilized by solid fat, such as whipped cream, quickly collapse when the solid fat contained therein is melted by temperature increase.

Non-dairy toppings are a widely-used substitute to dairy toppings. Industrial bakers and patissiers use these non-dairy alternatives because of their superior stability, making them ideal for decoration, coverings and fillings.

WO 98/31236 describes non-dairy whipped toppings comprising a temperature stabilizing effective amount of a non-tropical lauric oil. The patent examples describe whipped toppings that contain as the main components water (52.18 wt. %), oil (23.24 wt. %), high fructose corn syrup (24.18 wt. %), and 0.30 wt. % hydroxypropyl methylcellulose.

WO 2002/019840 describes non-dairy whipped toppings having enhanced temperature stability and good organoleptic properties. These whipped toppings contain as the main components water (20.3 wt. %) oil (24.2 wt. %), high fructose corn syrup (52.0 wt. %) and sodium caseinate (1.25 wt. %).

Cyclodextrins are a family of cyclic oligosaccharides that are produced from starch by means of enzymatic conversion. Cyclodextrins are composed of 5 or more α-(1,4) linked D-glucopyranoside units, as in amylose (a fragment of starch). Typical cyclodextrins contain a number of glucose monomers ranging from six to eight units in a ring, creating a cone shape:
α(alpha)-cyclodextrin: 6-membered sugar ring molecule
β(beta)-cyclodextrin: 7-membered sugar ring molecule
γ(gamma)-cyclodextrin: 8-membered sugar ring molecule

Because cyclodextrins have a hydrophobic inside and a hydrophilic outside, they can form complexes with hydrophobic compounds. Thus they can enhance the solubility and bioavailability of such compounds. This is of high interest for pharmaceutical as well as dietary supplement applications in which hydrophobic compounds shall be delivered. Alpha-, beta-, and gamma-cyclodextrin are all generally recognized as safe by the FDA.

The application of cyclodextrins in aerated oil-in-water emulsions has been described in patent publications.

US 2007/0003681 describes aerated food compositions containing protein, oil and cyclodextrin. The cyclodextrin is said to enable generation of a more stable and greater overrun protein-stabilized foam in the presence of liquid oils as compared to oil-containing food products lacking the cyclodextrin. The patent examples describe an ice cream containing skim milk (56.1 wt. %), canola oil (19.6 wt. %), sugar (17.4 wt. %), alpha cyclodextrin (6.5 wt. %) and vanilla extract (0.4 wt. %).

US 2008/0069924 describes a gasified food product comprising an alpha-cyclodextrin-gas clathrate. Food products mentioned in the US patent application are a dry mix, a liquid solution, a dough, a batter, a baked product, a ready-to-eat product, a ready-to-heat product, a liquid concentrate, a beverage, a frozen beverage, and a frozen product.

WO 2013/075939 describes aerated carbohydrate rich food compositions containing cyclodextrin. Examples 1-8 describe whipped apple sauces containing apple sauce, alpha-cyclodextrin (7 or 10 wt. %), vegetable oil (10 wt. %). Examples 32 and 33 describe whipped chocolate syrups containing chocolate syrup, soy oil (10 wt. %) and alpha-cyclodextrin (7.0 wt. %).

Although, as explained before, non-dairy whipped toppings are more stable than their dairy counterparts, there is a need for whipped toppings that are more stable than those currently available on the market. In particular, there is a need for whipped toppings that can be stored for several days under ambient or refrigerated conditions without significant loss of quality.

### SUMMARY OF THE INVENTION

The inventors have developed oil-in-water emulsions that can be aerated to produce foamed emulsions, e.g. toppings or fillings, that are highly stable under ambient conditions and that do not collapse at elevated temperatures.

The aeratable or aerated oil-in-water emulsion of the present invention comprises a continuous aqueous phase and a dispersed oil phase, said emulsion containing:
25-55 wt. % water;
4-50 wt. % oil;
3-12 wt. % of cyclodextrin selected from alpha-cyclodextrin, beta-cyclodextrin and combinations thereof;
20-60 wt. % of saccharides selected from monosaccharides, disaccharides, non-cyclic oligosaccharides, sugar alcohols and combinations thereof;
1-20 wt. % of polysaccharides;
0-30 wt. % of other edible ingredients;
   wherein the saccharides are contained in the emulsion in a concentration of at least 60% by weight of water and wherein the polysaccharides are contained in the emulsion in a concentration at least 2% by weight of water.

Although the inventors do not wish to be bound by theory, it is believed that the cyclodextrin in the present O/W emulsion accumulates at the oil-water interface where the hydrophobic inside of the cyclodextrin engages with fatty acid residues of the glycerides that make up the oil phase.

This interaction causes the formation of cyclodextrin-oil inclusion complexes that act as a structuring agent, fulfilling a similar role as crystalline fat in ordinary whipped toppings. It is believed that the very high level of saccharides and polysaccharides in the aqueous phase promotes the cyclodextrin-oil interaction, thereby strengthening the rigidity of the structuring network that is formed as a result of this interaction.

The ability of the present emulsion to produce a firm, stable aerated product is affected by the viscosity of the non-aerated emulsion. Although the inventors do not wish to be bound by theory, it is believed that a high viscosity enables entrapment and retention of air or other gas throughout the whipping process wherein gas cells are reduced to a small and stable size desired for whipped topping. Also, increasing the viscosity of the fluid phase occupying the space between gas cells reduces the rate of syrup drainage, thereby increasing shelf life. The viscosity of the present emulsion is affected by the saccharide content, the polysaccharide content and the presence of cyclodextrin-fat complexes.

The O/W emulsions of the present invention are capable of forming whipped toppings with high firmness and excellent shape retaining properties. In terms of taste and texture these whipped toppings are at least as good as existing non-dairy whipped toppings. The whipped toppings produced by aeration of the present O/W emulsion are clearly superior to existing whipped toppings in terms of stability, especially ambient stability.

The invention enables the preparation of aerated emulsions that are shelf-stable under ambient conditions for several days. Shape and textural properties (e.g. firmness, viscosity) of these aerated emulsions hardly change during storage. Since the emulsions typically have a very low water activity, they are sufficiently microbially stable to be kept under ambient conditions for several days.

It was surprisingly found that the aerated emulsion of the present invention can be heated to a temperature of 32° C. (90° F.), or even higher, without destabilizing. The aerated emulsion is also stable under refrigeration conditions and has freeze/thaw stability. The aerated emulsion may be stored at −23° C. (−9° F.) for 6 months. The inventors have found that upon thawing to 21° C. (70° F.) the aerated emulsion exhibits very good icing performance and stability at ambient temperature for at least 7 days or at refrigerated temperature (4° C./39° F.), for at least 14 days.

Thus, the aerated O/W emulsions of the present invention can suitably be used as a topping or filling for all types of foodstuffs, especially for foodstuffs that need to be shelf-stable under ambient conditions or that are subjected to elevated temperatures, e.g. when they are prepared for consumption.

### DETAILED DESCRIPTION OF THE INVENTION

Accordingly, a first aspect of the invention relates to an aeratable or aerated oil-in-water emulsion comprising a continuous aqueous phase and a dispersed oil phase, said emulsion containing:
25-55 wt. % water;
4-50 wt. % oil;
3-12 wt. % of cyclodextrin selected from alpha-cyclodextrin, beta-cyclodextrin and combinations thereof;
20-60 wt. % of saccharides selected from monosaccharides, disaccharides, non-cyclic oligosaccharides, sugar alcohols and combinations thereof;
1-20 wt. % of polysaccharides;
0-30 wt. % of other edible ingredients;
   wherein the saccharides are contained in the emulsion in a concentration of at least 60% by weight of water and wherein the polysaccharides are contained in the emulsion in a concentration at least 2% by weight of water.

The term “fat” and “oil” as used herein, unless indicated otherwise, refers to lipids selected from triglycerides, diglycerides, monoglycerides, fatty acids, phosphoglycerides and combinations thereof.

The term “alpha cyclodextrin” as used herein refers to a cyclic oligosaccharide of six glucose units that are covalently attached end to end via α-1,4 linkages.

The term “beta-cyclodextrin” as used herein refers to a cyclic oligosaccharide of seven glucose units that are covalently attached end to end via α-1, 4 linkages.

The term “oligosaccharide” as used herein refers to a saccharide polymer containing 3 to 9 monosaccharide units.

The term “polysaccharide” as used herein refers to a saccharide polymer containing 10 monosaccharide units or more. The term “polysaccharide” also encompasses modified polysaccharides, such a hydrolysed polysaccharides and chemically modified polysaccharides.

The term “sugar alcohol” as used herein refers to a polyol having the general formula H(HCHO)ₙH or C₆H₁₁O₆—CH₂—(HCHO)ₙH. Most sugar alcohols have five- or six carbon chains, because they are derived from pentoses (five-carbon sugars) and hexoses (six-carbon sugars), respectively. Other sugar alcohols may be derived from disaccharides and typically contain eleven or twelve carbon atoms. Examples of sugar alcohols containing 12 carbon atoms include mannitol and sorbitol. Erythritol is a naturally occurring sugar alcohol that contains only four carbon atoms.

The term “polysaccharide filler” as used herein refers to polysaccharides selected from hydrolysed starch, starch, inulin and combinations thereof.

The term “polysaccharide viscosifier” as used herein refers to polysaccharides that are not polysaccharide fillers and that are capable of substantially increasing the viscosity of aqueous liquids at low concentration, e.g. in concentrations of less than 5 wt. %.

The polysaccharide filler and the polysaccharide viscosifier may be introduced in the present emulsion in the form of ingredients that contain non-polysaccharide components, such as oligosaccharides, disaccharides and/or monosaccharides. These non-polysaccharide components are not considered to be encompassed by the term “polysaccharide filler” or “polysaccharide filler”.

The term “starch” refers to a polysaccharide (glucose polymer) that is produced by most green plants as an energy store. Starch consists of two types of molecules: the linear and helical amylose and the branched amylopectin.

The term “hydrolysed starch” as used herein in refers starch polymers that are obtained by breaking up the parent starch molecule into two or more parts by cleavage of one or more glycosidic bonds. Dextrins and maltodextrins are examples of hydolysed starches. Dextrins can be produced, for instance, from starch using enzymes like amylases, or by applying dry heat under acidic conditions. Dextrins produced by heat are also known as pyrodextrins. The term “hydrolysed starch” only encompasses polymers containing 10 monosaccharide units or more.

The term “inulin” refers to a group of naturally occurring polysaccharides produced by many types of plants. Inulin is a heterogeneous collection of fructose polymers. It consists of chain-terminating glucosyl moieties and a repetitive fructosyl moiety, which are linked by β(2,1) bonds. The degree of polymerization (DP) of inulin typically ranges from 10 to 60. Inulin is used by some plants as a means of storing energy and is typically found in roots or rhizomes. Most plants that synthesize and store inulin do not store other forms of carbohydrate such as starch.

The term “natural gum” as used herein refers to polysaccharides of natural origin, capable of causing a large increase in a solution's viscosity, even at small concentrations. In the food industry they are used as thickening agents, gelling agents, emulsifying agents, and stabilizers. Natural gums can be classified uncharged or ionic polymers (polyelectrolytes).

The term “carboxymethyl cellulose” as used herein refers to a cellulose derivative with carboxymethyl groups (—CH₂—COOH) bound to some of the hydroxyl groups of the glucopyranose monomers that make up the cellulose backbone.

The term “cellulose fibres” as used herein refers to natural cellulose fibers that have been isolated from plant material. The presence of linear chains of thousands of glucose units allows a great deal of hydrogen bonding between OH groups on adjacent cellulose chains, causing them to pack closely into cellulose fibers.

The term “pectin” as used herein refers to polysaccharides that are rich in galacturonic acid, including:
Homogalacturonans: linear chains of α-(1-4)-linked D-galacturonic acid.
Substituted galacturonans, characterized by the presence of saccharide appendant residues (such as D-xylose or D-apiose in the respective cases of xylogalacturonan and apiogalacturonan) branching from a backbone of D-galacturonic acid residues.
Rhamnogalacturonan I pectins (RG-I) contain a backbone of the repeating disaccharide: 4)-α-D-galacturonic acid-(1,2)-α-L-rhamnose-(1. From many of the rhamnose residues, sidechains of various neutral sugars branch off. The neutral sugars are mainly D-galactose, L-arabinose and D-xylose, with the types and proportions of neutral sugars varying with the origin of pectin.
Rhamnogalacturonan II (RG-II), a complex, highly branched polysaccharide with a backbone that is made exclusively of D-galacturonic acid units.

The terms “wt. %” and “% by weight” refer to the concentration expressed on a weight-by-weight basis (% (w/w)).

The term “specific gravity” as used herein refers to ratio of the density of the aerated O/W emulsion to the density (mass of the same unit volume) of water, both densities being determined at 20° C.

Whenever reference is made herein to the viscosity of an unaerated emulsion, unless indicated otherwise, this viscosity is determined at 38° C. (100° F.) at 20 rpm, using a Brookfield Digital Viscometer Model DV-E viscometer and Helipath spindle B.

Whenever reference is made herein to the viscosity of an aerated emulsion, unless indicated otherwise, this viscosity is determined at 20° C. (68° F.) at 10 rpm, using a Brookfield Digital Viscometer Model DV-E viscometer and Helipath spindle F.

The solid fat content of the oil phase at a particular temperature is determined by measuring the so called N-value at that temperature. The N value at temperature x ° C. is referred to in here as Nₓ and represents the amount of solid fat at a temperature of x ° C. These N-values can suitably be measured using the generally accepted analytical method that is based on NMR measurements (AOCS official method Cd 16b-93): Sample pre-treatment involves heating to 80° C. (176° F.) 15 minutes, 15 minutes at 60° C. (140° F.), 60 minutes at 0° C. (32° F.) and 30 minutes at the measuring temperature.

The non-aerated emulsion typically has a specific gravity of at least 1.0. Preferably, the non-aerated emulsion has specific gravity in the range of 1.05 to 1.7.

The inventors have found that the ability of the present emulsion to produce a firm, stable aerated product is greatly affected by the viscosity of the non-aerated emulsion. Preferably, the non-aerated emulsion has a viscosity of at least 100 cP (mPa·s) at 38° C. (100° F.) and 20 rpm. More preferably, the non-aerated emulsion has a viscosity of 200-40,000 cP, more preferably of 300-20,000 cP, and most preferably of 350-12,000 cP.

The emulsion according to the present invention, when aerated to a specific gravity in the range of 0.3 to 0.7 is very stable.

An aerated emulsion is considered stable when it passes the flow test. The flow test involves introducing the aerated emulsion to fill a 400 mL plastic funnel that is mounted on top of a collection container. The mouth of the funnel has an internal diameter of 124 mm, the stem of the funnel has an internal diameter of 11 mm. The conical receptacle of the funnel has a height of 140 mm. The funnel containing the aerated emulsion is kept at 20° C. and atmospheric pressure for 8 hours or even 12 hours. If during that time period the aerated emulsion does not flow through the funnel into the collection container, it has passed the test and is considered to be stable. If any aerated emulsion passes through the funnel than the aerated emulsion is considered to have failed the test and not to be stable.

The present emulsion, when aerated to a gravity in the range of 0.3 to 0.7 is capable of forming a well-defined shape after piping through star rosette tip and retains the shape, height, and definition when kept at 40° C. and atmospheric pressure for 15 hours (rosette test). Pictures are taken of the rosette immediately after piping. If after 15 hours at 40° C., upon visual inspection, the rosettes have not changed in definition, the emulsion has passed the rosette test. If the rosettes have changed shape, the aerated emulsion has failed the rosette test.

The O/W emulsion of the present invention offers the advantage that it can be produced with a very low water activity, meaning that the emulsion exhibits high microbiological stability. Preferably, the emulsion has a water activity of less than 0.95, more preferably of less than 0.92, even more preferably of less than 0.91 and most preferably of 0.80 to 0.90.

The aqueous phase of the O/W emulsion typically has a pH in the range of 5.0 to 7.0, more preferably of 5.1 to 6.4 and most preferably of 5.2 to 6.2.

The water content of the O/W emulsion preferably lies in the range of 27 wt. % to 52 wt. %. More preferably, the water content is in the range of 28-50 wt. %, most preferably in the range of 30-48 wt. %.

The oil contained in the present emulsion is preferably selected from vegetable oil, milk fat and combinations thereof. Vegetable oils preferably represent at least at least 50 wt. %, more preferably at least 80 wt. % and most preferably at least 90 wt. % of the oil.

Surprisingly, the aerated emulsion of the present invention does not require crystalline fat for stability. Thus, the present invention enables the preparation of stable aerated O/W emulsions that contain a reduced amount of high melting fat, notably fat containing saturated fatty acids (SAFA). Accordingly, in one embodiment of the invention, the oil present in the O/W emulsion contains not more than 40 wt. %, more preferably not more than 30 wt. % and most preferably not more than 20 wt. % of SAFA, calculated on total amount of fatty acid residues. Examples of low SAFA oils that may be employed include soybean oil, sunflower oil, rapeseed oil (canola oil), cottonseed oil and combinations thereof. Preferably, the oil contains at least 50 wt. %, more preferably at least 70 wt. % and most preferably at least 80 wt. % of vegetable oil selected from soybean oil, sunflower oil, rapeseed oil (canola oil), cottonseed oil, linseed oil, maize oil, safflower oil, olive oil and combinations thereof.

In case the O/W emulsion has a low SAFA content, said emulsion typically has a solid fat content at 20° C. (N₂₀) of less than 20%, more preferably of less than 14% and most preferably of less than 8%.

In accordance with another embodiment, the O/W emulsion contains a fat with a high SAFA content. The use of a fat with a high SAFA content offers the advantage that these fats enable the production of toppings and fillings that have very pleasant mouthfeel characteristics due to in-mouth melting of the fat component. Examples of fats with a high SAFA content that may suitably be employed include lauric fats such as coconut oil and palm kernel oil. Lauric fats offer the advantage that they rapidly melt in the temperature range of 20 to 30° C. and as a result are capable of imparting a cooling sensation when melting in the mouth. These lauric fats may be applied as such, or in the form of a fraction (e.g. a stearin fraction). Also hydrogenated and/or interesterified lauric fats can be applied. Preferably, the oil comprises at least 30 wt. %, more preferably at least 50 wt. % and most preferably at least 70 wt. % of lauric fat.

In case the O/W emulsion contains oil with a high SAFA content, the oil employed in the O/W emulsion typically has a solid fat content at 20° C. (N₂₀) of at least 10%, more preferably of at least 20% and most preferably of at least 30%. The solid fat content of the oil in the O/W emulsion preferably has a solid fat content at 35° C. (N₃₅) of less than 15%, more preferably of less than 12% and most preferably of less than 8%.

The oil of the present emulsion typically contains at least 80 wt. %, more preferably at least 90 wt. % of triglycerides.

The emulsion of the present invention preferably has an oil content of 5 wt. % to 30 wt. %. More preferably, the oil content is in the range of 6 to 25 wt. %, most preferably in the range of 8 to 20 wt. %.

The saccharides preferably constitute 22-50 wt. %, more preferably 25-45 wt. % and most preferably 30-40 wt. % of the emulsion. Saccharides represent the bulk of the solute present in the aqueous phase and have a significant influence on the viscosity and fluid dynamics of the O/W emulsion. The O/W emulsion preferably contains 65-200%, more preferably 68-180% and most preferably 70-110% of the saccharides by weight of water.

Monosaccharides preferably represent at least 40 wt. %, more preferably at least 55 wt. %, even more preferably at least 60 wt. % and most preferably at least 70 wt. % of the saccharides contained in the O/W emulsion. Preferably, the O/W emulsion contains 15-50 wt. %, more preferably 20-45 wt. % and most preferably 25-40 wt. % of monosaccharides selected from fructose, glucose and combinations thereof.

The monosaccharide content of the emulsion preferably is at least 60% by weight of water, more preferably at least 62% by weight of water and most preferably at least 64% by weight of water.

The O/W emulsion may suitably contain sugar alcohols. Sugar alcohols that are particularly suitable for use in the O/W emulsion include glycerol, erythritol, xylitol, mannitol, sorbitol, maltitol, lactitol and combinations thereof. Preferably, sugar alcohols are applied in the present emulsion in combination with monosaccharides.

The cyclodextrin employed in accordance with the present invention preferably is alpha-cyclodextrin.

Best results are obtained with the present O/W emulsion if it contains 4-10 wt. % of cyclodextrin. More preferably, the O/W emulsion contains 5-9 wt. % of cyclodextrin, even more preferably 6-8.5 wt. % of cyclodextrin and most preferably 6.5-8 wt. % of cyclodextrin.

The cyclodextrin content of the emulsion typically is in the range 20-120% by weight of the oil. More preferably, the cyclodextrin content is 25-85%, most preferably 28-60% by weight of oil. Expressed differently, the emulsion typically contains cyclodextrin and oil in a molar ratio of cyclodextrin to oil in the range of 1:5 to 1:1, more preferably of 1:4 to 1:2.

The cyclodextrin employed in accordance with the present invention preferably is not a cyclodextrin-gas clathrate.

The polysaccharide content of the present emulsion preferably is in the range of 2-18 wt. %, more preferably in the range of 3-15 wt. % and most preferably in the range of 5-12 wt. %.

Expressed differently, the polysaccharide content of the emulsion preferably is in the range of 3.0-40.0% by weight of water, more preferably 6.0.-.30.0.% by weight of water and most preferably 9.0-20.0% by weight of water.

The combination of the saccharides and the polysaccharides is typically present in the emulsion in a concentration of at least 70% by weight of water, more preferably in a concentration of at least 73% by weight of water and most preferably in a concentration of at least 75% by weight of water.

The polysaccharides in the present emulsion preferably comprise 1-30% by weight of water of polysaccharide component selected from polysaccharide filler, polysaccharide viscosifier and combinations thereof, said polysaccharide filler being selected from hydrolysed starch, starch, inulin and combinations thereof. More preferably, the polysaccharides comprise 3-40% by weight of water, even more preferably 6-30% by weight of water and most preferably 9-20% by weight of water of said polysaccharide component.

According to a particularly preferred embodiment, the polysaccharides comprise 1-25% by weight of water of the polysaccharide filler. More preferably, the polysaccharides comprise 3-20% by weight of water, more preferably 4-18% by weight of water, most preferably 5-12% by weight of water of the polysaccharide filler.

The polysaccharide filler employed in the present emulsion preferably is hydrolysed starch.Typically, the hydrolysed starch has a dextrose equivalent (DE) in the range of 1 to 20. More preferably, the hydrolysed starch has a DE in the range of 5-18, most preferably in the range of 6-15.

In accordance with another preferred embodiment, the polysaccharides comprise 0.01-20% by weight of water of polysaccharide viscosifier. More preferably, the polysaccharides comprise 0.1-10% by weight of water, even more preferably 0.2-8% by weight of water and most preferably 0.3-7% by weight of water of the polysaccharide viscosifier.

The emulsion typically contains 0.01-8 wt. % of the polysaccharide viscosifier. More preferably, the emulsion contains 0.03-6 wt. % of the polysaccharide viscosifier, most preferably 0.05-4 wt. % of the polysaccharide viscosifier.

Particular good results can be obtained in case the present emulsion contains a combination of the polysaccharide filler and the polysaccharide viscosifier. In case the emulsion contains a significant amount of polysaccharide viscosifier, the amount of polysaccharide filler need not be very high. Accordingly, in a preferred embodiment, the polysaccharides comprise 0.01-8% by weight of water of the polysaccharide viscosifier and 3-20% by weight of water of the polysaccharide filler. More preferably, the polysaccharides comprise 0.03-5% by weight of water of the polysaccharide viscosifier and 4-15% by weight of water of the polysaccharide filler. Most preferably, the polysaccharides comprise 0.05-3% by weight of water of the polysaccharide viscosifier and 5-14% by weight of water of the polysaccharide filler.

It is also possible to get good results if the present emulsion has a high content of polysaccharide filler and if it contains no or not more than a limited amount of polysaccharide viscosifier. Accordingly, in another preferred embodiment, the polysaccharides comprise 3-20% by weight of water of the polysaccharide filler and 0-3% by weight of water of the polysaccharide viscosifier. More preferably, the polysaccharides comprise 6-19% by weight of water of the polysaccharide filler and 0-2% by weight of water of the polysaccharide viscosifier. Most preferably, the polysaccharides comprise 7-17% by weight of water of the polysaccharide filler and 0-1% by weight of water of the polysaccharide viscosifier.

Examples of polysaccharide viscosifiers that can be applied in the present emulsion include natural gums, pectins, carboxymethyl cellulose, cellulose fibres and combinations thereof. In accordance with one embodiment of the present invention, the polysaccharide viscosifier is natural gum. The natural gum used can be a polyelectric natural gum or an uncharged natural gum. Examples of polyelectric natural gums that can suitably be used include gum arabic, gellan gum and combinations thereof. Examples of uncharged natural gum include guar gum, locust bean gum, xanthan gum and combinations thereof. The preferred uncharged natural gum is locust bean gum.

According to a particularly preferred embodiment, the natural gum employed in the present emulsion is selected from gum arabic, locust bean gum and combinations thereof. In accordance with another embodiment, the polysaccharide viscosifier is pectin. In accordance with a further embodiment, the polysaccharide viscosifier is carboxymethyl cellulose.

In accordance with yet another embodiment of the present invention, the polysaccharide viscosifier is cellulose fibre. The cellulose fibre employed preferably is defibrillated cellulose fibre. The cellulose fibre used preferably originates from citrus fruit or sugar beet, most preferably from citrus fruit.

The O/W emulsion can suitably contain a variety of other edible ingredients, i.e. edible ingredients other than oil, water, cyclodextrin and saccharides. Examples of other edible ingredients that may suitably be contained in the O/W include emulsifiers, hydrocolloids, non-saccharide sweeteners, acidulants, preservatives, flavorings, colorings, vitamins, minerals, anti-oxidants, cocoa solids, milk solids, plant extracts, fruit juices, vegetable purees and combinations thereof. Typically, the O/W emulsion contains 0.1-20 wt. %, more preferably 0.2-15 wt. % and most preferably 0.3-10 wt. % of the other edible ingredients.

In accordance with another preferred embodiment of the invention, the emulsion contains 0-3 wt. % of protein. Even more preferably, the emulsion contains 0-2 wt. % of protein and most preferably 0-1 wt. % of protein. Proteins that may suitably be employed in the emulsion include dairy proteins (e.g. non-fat dry milk, sodium caseinate and milk protein isolate) and vegetable proteins (e.g. soy protein isolate), dairy proteins being preferred. In non-dairy toppings proteins are widely used to improve whippability as well as foam stability. Surprisingly, the O/W emulsion of the present invention exhibit excellent whippability and foam stability even when no protein is contained in the emulsion.

The O/W emulsion of the present invention may suitably contain non-proteinaceous emulsifier. Examples of non-proteinaceous emulsifiers that can be employed include polysorbates (20, 40, 60, 65 & 80), sorbitan esters (Span 20, 40, 60, 65, 80, 85), polyglycerol esters of fatty acids, propylene glycol monostearate, propylene glycol monoesters, mono- and diglycerides of fatty acids, lactic acid esters of mono- and diglycerides of fatty acids, sucrose esters of fatty acids, sucroglycerides, sodium stearoyl lactylate and calcium stearoyl lactylate. Non-proteinaceous emulsifiers, notably emulsifiers having an HLB of 8 or more, are commonly used in whippable non-dairy creams to improve the whipping properties. The O/W emulsion of the present invention, however, does not require addition of non-proteinaceous emulsifier to achieve excellent whipping properties. Typically, the emulsion contains 0-1 wt. %, more preferably 0-0.5 wt. % and more preferably 0-0.3 wt. % of non-proteinaceous emulsifier having an HLB of 8 or more.

In accordance with a preferred embodiment, the present O/W emulsion is pourable at 38° C. Pourability ensures that the emulsion can easily be transferred from a container into, for instance, a whipping bowl.

The O/W emulsion of the present invention is preferably packaged in a sealed container. Since the present invention enables the preparation of aeratable emulsions with very low water activity it is not necessary to pasteurize or sterilize the emulsion. Preferably, the emulsion is a pasteurized emulsion.

The present invention pertains to non-aerated aeratable emulsions as well as to aerated O/W emulsions. The term “aerated” as used herein means that gas has been intentionally incorporated into an emulsion, for example, by mechanical means. The aerated emulsion preferably has a specific gravity of 0.25-0.75. More preferably, the aerated O/W emulsion has a specific gravity of 0.30-0.65, even more preferably a specific gravity of 0.32-0.55 and most preferably a specific gravity of 0.35-0.50.

The aerated emulsion of the present invention preferably is a firm foam that retains shape and definition for several days. The aerated emulsion preferably passes the flow test described herein before.

The aerated emulsion preferably is capable of forming a well-defined shape and passes the rosette test described herein before.

Typically, the aerated emulsion has a viscosity of at least 10,000 cP (mPa·s) at 20° C. (68° F.) and 10 rpm. More preferably, the aerated emulsion has a viscosity of at least 40,000 cP, more preferably of at least 60,000 cP, and most preferably of 80,000-2,000,000 cP. It is noted that the viscosity of the freshly prepared aerated emulsion can be considerably lower than the viscosity of the same emulsion after it has been kept for a few hours at ambient conditions. The aerated emulsion of the present invention may be frozen or non-frozen. The benefits of the present invention are particularly pronounced in aerated emulsions that are not frozen.

The aerated emulsions of the present invention exhibit exceptional stability. The specific gravity of the aerated emulsion of the present invention typically increases with not more than 20%, preferably with not more than 15% and most preferably with not more than 10% when the aerated emulsion is kept under ambient conditions for 1 day.

When the aerated emulsion is kept under ambient conditions for 7 days, the specific gravity of the aerated emulsion preferably does not increase with not more than 20%, more preferably with not more than 15% and most preferably with not more thanl0%.

The aerated emulsion according to the invention preferably exhibits excellent heat stability in that the specific gravity of the aerated emulsion does not increase with not more than 12%, more preferably with not more than 8% and most preferably with not more than 4% when the aerated emulsion is kept at a temperature of 32° C. (99.6° F.) for 12 hours.

The stability of the aerated emulsion is further demonstrated a constant viscosity during ambient storage. Typically, the viscosity of the aerated emulsion (20° C. (68° F.), 10 rpm, spindle F) changes not more than 50%, more preferably not more than 30% and most preferably not more than 20% if the emulsion is kept at a temperature of 20° C. (68° F.) for 12 hours, or even for 48 hours.

Even if the aerated emulsion is heated to a temperature as high as 80° C. (176° F.), the specific gravity of the emulsion typically does not increase by more than 5% if the aerated emulsion is kept at this temperature for 5 minutes.

The quality of the aerated emulsion of the present invention remains essentially unchanged when the emulsion is kept under ambient conditions for several days (e.g. 1, 2 or 7 days),whereas an equivalent aerated emulsion lacking the cyclodextrin component quickly destabilizes under these same conditions.

Another aspect of the invention relates to a foodstuff comprising 0.5-50 wt. %, more preferably 1-20 wt. % of the aerated emulsion as described herein before.

Examples of foodstuffs encompassed by the present invention include cake, pie, custard, non-frozen dessert, frozen dessert, ice cream, fruit pieces and confectionary. The foodstuff can contain the aerated emulsion as a covering, as filling layers and/or as a core filling. Preferably, the foodstuff contains the aerated emulsion as a covering, e.g. as a topping, a frosting or an icing. Most preferably, the foodstuff contains the aerated emulsion as a topping. The aerated topping has suitably been applied onto the foodstuff in the form of extruded discrete amounts of topping.

The foodstuff of the present invention typically has a shelf life under ambient conditions of at least 5 days, more preferably of at least 7 days and most preferably of at least 10 days.

The invention also provides a method of preparing a foodstuff as described herein before, said method comprising heating the foodstuff containing the aerated emulsion to a temperature in excess of 60° C. (140° F.) for at least 1 minute, preferably for at least 3 minutes.

The invention is further illustrated by the following non-limiting examples.

### EXAMPLES

### Example 1

A whippable topping was prepared on the basis of the recipe shown in Table 1.

TABLE 1

| Ingredient | Wt. % |
|---|---|
| Fat ¹ | 8.97 |
| Alpha-cyclodextrin ² | 6.49 |
| High fructose corn syrup (42%) ³ | 48.93 |
| Waxy maize dextrin ⁴ | 3.63 |
| Sodium carboxymethyl cellulose ⁵ | 0.20 |
| Modified instant corn starch ⁶ | 1.00 |
| Sodium chloride | 0.40 |
| Sodium alginate ⁷ | 0.20 |
| Calcium sulfate | 0.10 |
| Water | 29.78 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Cargill Plus ™ 08602, estimated polysaccharide content: 86 wt. % (ex Cargill, USA)
⁵ Methocel ® (ex Dow, USA)
⁶ Inscosity ® B656 pregelatinized modified starch (ex Grain Processing Corp., USA)
⁷ Dariloid ® QH (ex FMC BioPolymer, USA)

The total water content of the emulsion was appr. 45 wt. %. Saccharide content was appr. 35 wt. % and polysaccharide content was appr. 5 wt. %.

The whippable emulsion was prepared using the following procedure:
Place the high fructose corn syrup (HFCS) in a high shear blender (Waring multispeed blender) and add the sodium carboxymethyl cellulose (CMC), starch, salt, dextrin, cream flavour with high speed mixing. Mix for 3 minutes under maximum shear. Use microscope to confirm that CMC is fully dispersed.
Melt the oil/shortening at 46° C. (115° F.) and stir in all the alpha-cyclodextrin to disperse the cyclodextrin throughout the oil.
Heat water and cyclodextrin while stirring until 60° C. (140° F.).
Introduce the HFCS-containing dry mix into the mixing bowl of a Hobart mixer (Model N-50 table top mixer, standard paddle). Add the oil. Stir at speed 1 until well mixed. This takes about 1-2 minutes, during which time the viscosity increases. With the mixer running on Speed 1 slowly pour in the water/cyclodextrin until thoroughly combined. Viscosity will increase noticeably. Total mix time for this step is about 2 minutes.
During these steps the temperature of the mixture should be kept above melting point of the fat.

The emulsion so obtained had a viscosity of appr. 1,100 cP at 100° F. and 20 rpm, spindle B.

Next, the emulsion so obtained was converted into a whipped topping using the following procedure:
Replace the mixing paddle of the Hobart mixer with whip (Wire Whip D) and then mix on Speed 3.
Aerate the topping to a specific gravity of 0.35-0.55 to obtain a topping with a texture suitable for cake decorating.

During whipping the viscosity of the emulsion rapidly increased. The properties of the whipped topping are summarized in Table 2.

TABLE 2

| | |
|---|---|
| pH | 7.1 |
| Water activity | 0.90 |
| Specific gravity | 0.40 |
| Viscosity freshly prepared ¹ | 134,000 cP |
| Viscosity after 12 hours ambient ¹ | 475,000 cP |

¹ 68° F., 10 rpm, Helipath spindle F

The whipped topping showed excellent ambient stability. When the whipped topping was piped through a star tip into rosettes, resulting rosettes possessed a full body and sharp ridges with a glossy appearance. Rosettes stored at ambient and elevated temperature (40° C.) over a 12 hour period maintained their shape and appearance. The whipped topping showed that it was sufficiently viscous and stable to pass the flow test (described herein before), whereby all of the whipped topping remained within a funnel suspended over a collection container stored at ambient temperature over a 12 hour period.

### Comparative Example A

A whippable topping was prepared on the basis of the recipe shown in Table 3.

TABLE 3

| Ingredient | Wt. % |
|---|---|
| Fat ¹ | 9.06 |
| Alpha-cyclodextrin ² | 6.55 |
| High fructose corn syrup (42%) ³ | 50.96 |
| Sodium carboxymethyl cellulose ⁴ | 0.20 |
| Modified instant corn starch ⁵ | 1.01 |
| Sodium chloride | 0.40 |
| Sodium alginate ⁶ | 0.20 |
| Calcium sulfate | 0.10 |
| Water | 31.22 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Methocel ® (ex Dow, USA)
⁵ Inscosity ® B656 pregelatinized modified starch (ex Grain Processing Corp., USA)
⁶ Dariloid ® QH (ex FMC BioPolymer, USA)

The total water content of the emulsion was appr. 47 wt. %. Saccharide content was appr. 36 wt. % and polysaccharide content was appr. 1 wt. %.

A whippable emulsion was prepared using the procedure described in Example 1. The emulsion had a viscosity of appr. 530 cP (100° F., 20 rpm, Helipath spindle B).

The emulsion was whipped using the procedure described in Example 1 to obtain a whipped topping with the properties described in Table 4

TABLE 4

| | |
|---|---|
| pH | 7.5 |
| Water activity | 0.90 |
| Specific gravity | 0.45 |
| Viscosity freshly prepared ¹ | 90,000 |
| Viscosity after 12 hours ambient ¹ | 55,000 |

¹ 68° F., 10 rpm, Helipath spindle F

The whipped topping was not stable. The whipped topping failed the rosette test. The whipped topping exhibited poor piping characteristics through a star tip. Resulting rosettes showed soft edges and lacked body. Rosettes stored at ambient and elevated temperature (40° C.) over the 12 hour period lost the definition in their edges and their glossy appearance. This whipped topping would not be considered viscous or stable enough for decoration purposes.

### Example 2

A whippable topping was prepared on the basis of the recipe shown in Table 5.

TABLE 5

| Ingredient | Wt. % |
|---|---|
| Fat ¹ | 9.04 |
| Alpha-cyclodextrin ² | 6.54 |
| High fructose corn syrup (42%) ³ | 46.63 |
| Waxy maize dextrin ⁴ | 7.52 |
| Sodium carboxymethyl cellulose ⁵ | 0.20 |
| Modified instant corn starch ⁶ | 1.01 |
| Sodium chloride | 0.40 |
| Sodium alginate ⁷ | 0.20 |
| Calcium sulfate | 0.10 |
| Water | 28.07 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Cargill Plus ™ 08602, estimated polysaccharide content: 86 wt. % (ex Cargill, USA)
⁵ Methocel ® (ex Dow, USA)
⁶ Inscosity ® B656 pregelatinized modified starch (ex Grain Processing Corp., USA)
⁷ Dariloid ® QH (ex FMC BioPolymer, USA)

The total water content of the emulsion was appr. 43 wt. %. Saccharide content was appr. 33 wt. % and polysaccharide content was appr. 8 wt. %.

A whippable emulsion was prepared using the procedure described in Example 1. The emulsion had a viscosity of appr. 770 cP (100° F., 20 rpm, Helipath spindle B).

The emulsion was whipped using the procedure described in Example 1 to obtain a whipped topping with the properties described in Table 6.

TABLE 6

| | |
|---|---|
| pH | 6.8 |
| Water activity | 0.89 |
| Specific gravity | 0.41 |
| Viscosity freshly prepared ¹ | 150,000 cP |
| Viscosity after 12 hours ambient ¹ | 1,000,000 cP |

¹ 68° F., 10 rpm, Helipath spindle F

The whipped topping displayed excellent ambient stability. The whipped topping passed the rosette test. When the whipped topping was piped through a star tip into rosettes, resulting rosettes possessed full body and sharp ridges with a glossy appearance. Rosettes stored at ambient and elevated temperature (40° C.) over a 12 hour period maintained their shape and appearance. The whipped topping showed that it was sufficiently viscous and stable to pass the flow test, whereby all of the whipped topping remained within a funnel suspended over a collection container stored at ambient temperature over a 12 hour period.

### Example 3

Whippable toppings was prepared on the basis of the recipes shown in Table 7.

TABLE 7

Wt. %

| Ingredient | A | B |
|---|---|---|
| Fat ¹ | 9.43 | 8.98 |
| Alpha-cyclodextrin ² | 6.82 | 6.49 |
| High fructose corn syrup (42%) ³ | 48.50 | 46.32 |
| Waxy maize dextrin ⁴ | 1.73 | 3.30 |
| Gum Arabic ⁵ | 1.87 | 4.76 |
| Sodium carboxymethyl cellulose ⁶ | 0.21 | 0.20 |
| Modified instant corn starch ⁷ | 1.05 | 1.00 |
| Sodium chloride | 0.42 | 0.40 |
| Sodium alginate ⁸ | 0.21 | 0.20 |
| Calcium sulfate | 0.10 | 0.10 |
| Water | 29.35 | 27.95 |
| Cream flavour | 0.31 | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Cargill Plus ™ 08602, estimated polysaccharide content: 86 wt. % (ex Cargill, USA)
⁵ Gum Arabic FT Powder (ex Texture Innovation Center, USA)
⁶ Methocel ® (ex Dow, USA)
⁷ Inscosity ® B656 pregelatinized modified starch (ex Grain Processing Corp., USA)
⁸ Dariloid ® QH (ex FMC BioPolymer, USA)

The total water content of emulsion A was appr. 44 wt. %. Saccharide content was appr. 34 wt. % and polysaccharide content was appr. 4 wt. %. The total water content of emulsion B was appr. 43 wt. %. Saccharide content was appr. 33 wt. % and polysaccharide content was appr. 8 wt. %.

Whippable emulsions were prepared using the procedure described in Example 1. Emulsion A had a viscosity of appr. 520 cP (100° F., 20 rpm, Helipath spindle B). Emulsion B had a viscosity of appr. 260 cP (100° F., 20 rpm, Helipath spindle B).

The emulsions were whipped using the procedure described in Example 1 to obtain whipped toppings with the properties described in Table 8.

TABLE 8

| | A | B |
|---|---|---|
| pH | 6.8 | 6.8 |
| Water activity | 0.89 | 0.90 |
| Specific gravity | 0.39 | 0.42 |
| Viscosity freshly prepared ¹ | 170,000 cP | 140,000 cP |
| Viscosity after 12 hours ambient ¹ | 930,000 cP | 840,000 cP |

¹ 68° F., 10 rpm, Helipath spindle F

The whipped toppings displayed excellent ambient stability. The whipped topping passed the rosette test. When the whipped topping was piped through a star tip into rosettes, resulting rosettes possessed full body and crisp ridges with a glossy appearance. Rosettes stored at ambient and elevated temperature (40° C.) over a 12 hour period maintained their shape and appearance. The whipped topping showed that it was sufficiently viscous and stable to pass the flow test, whereby all of the whipped topping remained within a funnel suspended over a collection container stored at ambient temperature over a 12 hour period.

### Example 4

A whippable topping was prepared on the basis of the recipe shown in Table 9.

TABLE 9

| Ingredient | Wt. % |
|---|---|
| Fat ¹ | 9.06 |
| Alpha-cyclodextrin ² | 6.55 |
| High fructose corn syrup (42%) ³ | 42.17 |
| Maltodextrin ⁴ | 3.33 |
| Tapioca starch ⁵ | 3.33 |
| Sodium carboxymethyl cellulose ⁶ | 0.20 |
| Modified instant corn starch ⁷ | 1.01 |
| Sodium chloride | 0.40 |
| Water | 33.65 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Maltrin ® M100, DE 9.0-12.0 (ex. Grain Processing Corp., USA) max. water content is 6%
⁵ ULTRA-TEX ® 2, modified waxy maize starch (ex National Starch and Chemical Company, USA)
⁶ Methocel ® (ex Dow, USA)
⁷ Inscosity ® B656 pregelatinized modified starch (ex Grain Processing Corp., USA)

The total water content of the emulsion was appr. 47 wt. %. Saccharide content was appr. 37 wt. % and polysaccharide content was appr. 4wt. %.

A whippable emulsion was prepared using the procedure described in Example 1. The emulsion had a viscosity of appr. 2900 cP (100° F., 20 rpm, Helipath spindle B).

The emulsion was whipped using the procedure described in Example 1 to obtain a whipped topping with the properties described in Table 10.

TABLE 10

| | |
|---|---|
| pH | 5.3 |
| Water activity | 0.92 |
| Specific gravity | 0.52 |
| Viscosity freshly prepared ¹ | 170,000 cP |
| Viscosity after 12 hours ambient ¹ | 217,000 cP |

¹ 68° F., 10 rpm, Helipath spindle F

The whipped topping displayed good ambient stability. The whipped topping passed the rosette test. When the whipped topping was piped through a star tip into rosettes, resulting rosettes possessed full body, sharp ridges, and a glossy appearance. The appearance of rosettes stored at ambient temperature were consistent with the initial rosettes. The rosettes stored at an elevated temperature were more matte or lost some of their gloss. Despite the small shift in color, their shape was consistent with initial rosettes the shift in appearance was very minor, therefore they were considered good. The whipped topping showed that it was sufficiently viscous and stable to pass the flow test, whereby all of the whipped topping remained within a funnel suspended over a collection container stored at ambient temperature over a 12 hour period.

### Example 5

A whippable topping was prepared on the basis of the recipe shown in Table 11.

TABLE 11

| Ingredient | Wt. % |
|---|---|
| Fat ¹ | 9.06 |
| Alpha-cyclodextrin ² | 6.55 |
| High fructose corn syrup (42%) ³ | 42.17 |
| Maltodextrin ⁴ | 3.33 |
| Wheat starch ⁵ | 3.33 |
| Sodium carboxymethyl cellulose ⁶ | 0.20 |
| Modified instant corn starch ⁷ | 1.01 |
| Sodium chloride | 0.40 |
| Water | 33.65 |
| Cream flavour | 0.30 |

1 Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Maltrin ® M100, DE 9.0-12.0 (ex. Grain Processing Corp., USA) max. water content is 6%
⁵ GEMGEL 100, pregelatinized wheat starch (ex Manildra Milling Corp., USA)
⁶ Methocel ® (ex Dow, USA)
⁷ Inscosity ® B656 pregelatinized modified starch (ex Grain Processing Corp., USA)

The total water content of the emulsion was appr. 47 wt. %. Saccharide content was appr. 37 wt. % and polysaccharide content was appr. 4 wt. %.

A whippable emulsion was prepared using the procedure described in Example 1. The emulsion had a viscosity of appr. 3500 cP (100° F., 20 rpm, Helipath spindle B).

The emulsion was whipped using the procedure described in Example 1 to obtain a whipped topping with the properties described in Table 12.

TABLE 12

| | |
|---|---|
| pH | 6.1 |
| Water activity | 0.92 |
| Specific gravity | 0.43 |
| Viscosity freshly prepared ¹ | 150,000 cP |
| Viscosity after 12 hours ambient ¹ | 260,000 cP |

¹ 68° F., 10 rpm, Helipath spindle F

The whipped topping displayed excellent ambient stability. The whipped topping passed the rosette test. When the whipped topping was piped through a star tip into rosettes, rosettes possessed full body, sharp ridges, a long texture, and a glossy appearance. Rosettes stored at ambient and elevated temperature (40° C.) over a 12 hour period maintained their shape and appearance. The whipped topping showed that it was sufficiently viscous and stable to pass the flow test, whereby all of the whipped topping remained within a funnel suspended over a collection container stored at ambient temperature over a 12 hour period.

### Example 6

A whippable topping was prepared on the basis of the recipe shown in Table 13.

TABLE 13

| Ingredient | Wt. % |
|---|---|
| Fat ¹ | 9.06 |
| Alpha-cyclodextrin ² | 6.55 |
| High fructose corn syrup (42%) ³ | 43.90 |
| Maltodextrin ⁴ | 3.33 |
| Caboxymethyl cellulose ⁵ | 1.60 |
| Sodium carboxymethyl cellulose ⁶ | 0.20 |
| Modified instant corn starch ⁷ | 1.01 |
| Sodium chloride | 0.40 |
| Water | 33.65 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Maltrin ® M100, DE 9.0-12.0 (ex. Grain Processing Corp., USA) max. water content is 6%
⁵ CMC 16 F (ex TIC Gums, Inc., USA)
⁶ Methocel ® (ex Dow, USA)
⁷ Inscosity ® B656 pregelatinized modified starch (ex Grain Processing Corp., USA)

The total water content of the emulsion was appr. 47 wt. %. Saccharide content was appr. 37 wt. % and polysaccharide content was appr. 4 wt. %.

A whippable emulsion was prepared using the procedure described in Example 1. The emulsion had a viscosity of appr. 600 cP (100° F., 20 rpm, Helipath spindle B).

The emulsion was whipped using the procedure described in Example 1 to obtain a whipped topping with the properties described in Table 14.

TABLE 14

| | |
|---|---|
| pH | 6.6 |
| Water activity | 0.92 |
| Specific gravity | 0.48 |
| Viscosity freshly prepared ¹ | 83,000 cP |
| Viscosity after 12 hours ambient ¹ | 115,000 cP |

¹ 68° F., 10 rpm, Helipath spindle F

The whipped toppings displayed excellent ambient stability. The whipped topping passed the rosette test. When the whipped topping was piped through a star tip into rosettes, resulting rosettes possessed a full body and well defined ridges. The topping had a very glossy appearance. Rosettes stored at ambient and elevated temperature (40° C.) over a 12 hour period maintained their shape and appearance. The whipped topping passed the flow test, showing sufficient viscosity and stability to remain within a funnel suspended over a collection container stored at ambient temperature over a 12 hour period.

### Example 7

A whippable topping was prepared on the basis of the recipe shown in Table 15

TABLE 15

| Ingredient | Wt. % |
|---|---|
| Fat ¹ | 9.06 |
| Alpha-cyclodextrin ² | 6.55 |
| High fructose corn syrup (42%) ³ | 45.30 |
| Maltodextrin ⁴ | 3.33 |
| Locust bean gum ⁵ | 0.20 |
| Sodium carboxymethyl cellulose ⁶ | 0.20 |
| Modified instant corn starch ⁷ | 1.01 |
| Sodium chloride | 0.40 |
| Water | 33.65 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Maltrin ® M100, DE 9.0-12.0 (ex. Grain Processing Corp., USA) max. water content is 6%
⁵ MEYPRODYN ™ 200 (ex Danisco, USA)
⁶ Methocel ® (ex Dow, USA)
⁷ Inscosity ® B656 pregelatinized modified starch (ex Grain Processing Corp., USA)

The total water content of the emulsion was appr. 48 wt. %. Saccharide content was appr. 37 wt. % and polysaccharide content was appr. 4 wt. %.

A whippable emulsion was prepared using the procedure described in Example 1. The emulsion had a viscosity of appr. 5300 cP (100° F., 20 rpm, Helipath spindle B).

The emulsion was whipped using the procedure described in Example 1 to obtain a whipped topping with the properties described in Table 16.

TABLE 16

| | |
|---|---|
| pH | 6.0 |
| Water activity | 0.92 |
| Specific gravity | 0.68 |
| Viscosity freshly prepared ¹ | 150,000 cP |
| Viscosity after 12 hours ambient ¹ | 210,000 cP |

¹ 68° F., 10 rpm, Helipath spindle F

The whipped topping displayed good ambient stability. The whipped topping passed the rosette test. When the whipped topping was piped through a star tip into rosettes, resulting rosettes possessed full body, glossy appearance, medium ridges. The appearance of rosettes stored at ambient and elevated temperatures were consistent with the initial rosettes, retaining, body, gloss, and moderate ridge definition. The texture of the whipped topping differed from other whipped toppings tested in that the texture was shorter and more elastic, but the product remained consistent throughout ambient and elevated temperatures. The whipped topping showed that it was sufficiently viscous and stable to pass the flow test, whereby all of the whipped topping remained within a funnel suspended over a collection container stored at ambient temperature over a 12 hour period.

### Example 8

A whippable topping was prepared on the basis of the recipe shown in Table 17.

TABLE 17

| Ingredient | Wt. % |
|---|---|
| Fat ¹ | 9.03 |
| Alpha-cyclodextrin ² | 6.53 |
| High fructose corn syrup (42%) ³ | 44.68 |
| Maltodextrin ⁴ | 3.32 |
| Low methoxyl pectin ⁵ | 1.00 |
| Sodium carboxymethyl cellulose ⁶ | 0.20 |
| Modified instant corn starch ⁷ | 1.01 |
| Sodium chloride | 0.40 |
| Water | 33.53 |
| Cream flavour | 0.30 |

¹ Ultimate ® 92 (ex Cargill, USA), refined, bleached, hydrogenated and deodorized coconut oil; Iodine Value = 1.5, Mettler Dropping Point94-100° F.
² Cavamax ® W6 (ex Wacker Biosolutions, Germany) - Water content is 11% max.
³ IsoClear ® (ex Cargill, USA) - Water content is 29%
⁴ Maltrin ® M100, DE 9.0-12.0 (ex. Grain Processing Corp., USA) max. water content is 6%
⁵ GENU ® pectin type LM-22 CG (ex CPKelco, USA)
⁶ Methocel ® (ex Dow, USA)
⁷ Inscosity ® B656 pregelatinized modified starch (ex Grain Processing Corp., USA)

The total water content of the emulsion was appr. 48 wt. %. Saccharide content was appr. 37 wt. % and polysaccharide content was appr. 4 wt. %.

The emulsion was whipped using the following procedure to obtain a whipped topping with the properties described in Table 18:
Place the high fructose corn syrup (HFCS) in a high shear blender (Waring multispeed blender) and add the low methoxyl pectin,sodium carboxymethyl cellulose (CMC), starch, salt, maltodextrin, cream flavour with high speed mixing. Mix for 3 minutes under maximum shear. Use microscope to confirm that CMC is fully dispersed.
Pour the HFCS-containing dry mix into a pan with the water and cyclodextrin and bring to a rolling boil for four minutes.
Introduce the boiled mixture to the mixing bowl of a Hobart mixer (Model N-50 table top mixer, standard paddle). Add the oil. Stir at speed 1 until well mixed. This takes about 1-2 minutes, during which time the viscosity increases. Viscosity will increase noticeably. Total mix time for this step is about 2 minutes.
Cool mixture to approx. 45° C. (113° F.) or slightly above melthing point of the fat.

The emulsion so obtained had a viscosity of appr. 500 cP at 100° F. and 20 rpm, spindle B.

Next, the emulsion so obtained was converted into a whipped topping using the following procedure:
Replace the mixing paddle of the Hobart mixer with whip (Wire Whip D) and then mix on Speed 3.
Aerate the topping to a specific gravity of 0.35-0.55 to obtain a topping with a texture suitable for cake decorating.

During whipping the viscosity of the emulsion rapidly increased. The properties of the whipped topping are summarized in Table 18.

TABLE 18

| | |
|---|---|
| pH | 3.5 |
| Water activity | 0.90 |
| Specific gravity | 0.46 |
| Viscosity freshly prepared ¹ | 130,000 cP |
| Viscosity after 12 hours ambient ¹ | 145,000 cP |

¹ 68° F., 10 rpm, Helipath spindle F

The whipped topping displayed excellent ambient stability. The whipped topping passed the rosette test. When the whipped topping was piped through a star tip into rosettes, resulting rosettes possessed a full body and well defined ridges. The topping had a very glossy appearance. Rosettes stored at ambient and elevated temperature (40° C.) over a 12 hour period maintained their well defined shape and glossy appearance. The whipped topping passed the flow test, showing sufficient viscosity and stability to remain within a funnel suspended over a collection container stored at ambient temperature over a 12 hour period.

### Example 9

A whippable topping was prepared on the basis of the recipe shown in Table 19.

TABLE 19

| Ingredient | Wt. % |
|---|---|
| Fat ¹ | 9.03 |
| Alpha-cyclodextrin ² | 6.53 |
| High fructose corn syrup (42%) ³ | 44.68 |
| Maltodextrin ⁴ | 3.32 |
| High methoxyl pectin ⁵ | 1.00 |
| Sodium carboxymethyl cellulose ⁶ | 0.20 |
| Modified instant corn starch ⁷ | 1.01 |
| Sodium chloride | 0.40 |
| Water | 33.65 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Maltrin ® M100, DE 9.0-12.0 (ex. Grain Processing Corp., USA) max. water content is 6%
⁵ Pectin Classic CF 501(ex Herbstreith & Fox KG, Germany)
⁶ Methocel ® (ex Dow, USA)
⁷ Inscosity ® B656 pregelatinized modified starch (ex Grain Processing Corp., USA)

The total water content of the emulsion was appr. 48 wt. %. Saccharide content was appr. 37 wt. % and polysaccharide content was appr. 4 wt. %.

A whippable emulsion was prepared using the procedure described in Example 9. The emulsion had a viscosity of appr. 800 cP (100° F., 20 rpm, Helipath spindle B).

The emulsion was whipped using the procedure described in Example 9 to obtain a whipped topping with the properties described in Table 20.

TABLE 20

| | |
|---|---|
| pH | 3.6 |
| Water activity | 0.90 |
| Specific gravity | 0.47 |
| Viscosity freshly prepared ¹ | 150,000 cP |
| Viscosity after 12 hours ambient ¹ | 185,000 cP |

¹ 68° F., 10 rpm, Helipath spindle F

The whipped topping displayed good ambient stability. The whipped topping passed the rosette test. When the whipped topping was piped through a star tip into rosettes, resulting rosettes possessed full body, sharp ridges, and a glossy appearance. The appearance of rosettes stored at ambient temperature were consistent with the initial rosettes. The rosettes stored at an elevated temperature were more matte or lost some of their gloss. Despite the small shift in color, their shape was consistent with initial rosettes the shift in appearance was very minor, therefore they were considered good. The whipped topping showed that it was sufficiently viscous and stable to pass the flow test, whereby all of the whipped topping remained within a funnel suspended over a collection container stored at ambient temperature over a 12 hour period.

### Example 10

A whippable topping was prepared on the basis of the recipe shown in Table 21.

TABLE 21

| Ingredient | Wt. % |
|---|---|
| Fat ¹ | 8.94 |
| Alpha-cyclodextrin ² | 6.48 |
| High fructose corn syrup (42%) ³ | 48.61 |
| Waxy maize dextrin ⁴ | 0.73 |
| Citrus fibre ⁵ | 3.30 |
| Sodium carboxymethyl cellulose ⁶ | 0.20 |
| Modified instant corn starch ⁷ | 1.00 |
| Sodium chloride | 0.40 |
| Sodium alginate ⁸ | 0.20 |
| Calcium sulfate | 0.10 |
| Water | 29.74 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Cargill Plus ™ 08602, estimated polysaccharide content: 86 wt. % (ex Cargill, USA)
⁵ Citri-Fi ® 200FG, estimated polysaccharide content 90 wt % (ex. Fiberstar Inc., USA)
⁶ Methocel ® (ex Dow, USA)
⁷ Inscosity ® B656 pregelatinized modified starch (ex Grain Processing Corp., USA)
⁸ Dariloid ® QH (ex FMC BioPolymer, USA)

The total water content of the emulsion was appr. 45 wt. %. Saccharide content was appr. 35 wt. % and polysaccharide content was appr. 5 wt. %.

A whippable emulsion was prepared using the procedure described in Example 1. The emulsion had a viscosity of appr. 15,000 cP (100° F., 20 rpm, Helipath spindle B).

The emulsions were whipped using the procedure described in Example 1 to obtain whipped toppings with the properties described in Table 22.

TABLE 22

| | |
|---|---|
| pH | 5.4 |
| Water activity | 0.90 |
| Specific gravity | 0.58 |
| Viscosity freshly prepared ¹ | 240,000 cP |
| Viscosity after 12 hours ambient ¹ | 330,000 cP |

¹ 68° F., 10 rpm, Helipath spindle F

The whipped topping displayed good ambient stability. The whipped topping passed the rosette test. When the whipped topping was piped through a star tip into rosettes, resulting rosettes possessed full body, sharp ridges, and a matte appearance. The appearance of rosettes stored at ambient and elevated temperatures retained their full body, sharp rideges, and matte appearance The whipped topping showed that it was sufficiently viscous and stable to pass the flow test, whereby all of the whipped topping remained within a funnel suspended over a collection container stored at ambient temperature over a 12 hour period.

### Comparative Example B

A whippable topping was prepared on the basis of the recipe shown in Table 23.

TABLE 23

| Ingredient | Wt. % |
|---|---|
| Fat ¹ | 9.06 |
| Alpha-cyclodextrin ² | 6.55 |
| High fructose corn syrup (42%) ³ | 48.63 |
| Sodium carboxymethyl cellulose ⁴ | 0.20 |
| Modified instant corn starch ⁵ | 1.01 |
| Sodium chloride | 0.40 |
| Sodium alginate ⁶ | 0.20 |
| Water | 33.65 |
| Cream flavour | 0.30 |

¹ Ultimate ® 92 (ex Cargill, USA), refined, bleached, hydrogenated and deodorized coconut oil; Iodine Value = 1.5, Mettler Dropping Point 94-100° F.
² Cavamax ® W6 (ex Wacker Biosolutions, Germany) - Water content is 11% max.
³ IsoClear ® (ex Cargill, USA) - Water content is 29%
⁴ Methocel ® (ex Dow, USA)
⁵ Inscosity ® B656 pregelatinized modified starch (ex Grain Processing Corp., USA)
⁶ Dariloid ® QH (ex FMC BioPolymer, USA)

The total water content of the emulsion was appr. 47 wt. %. Saccharide content was appr. 36 wt. % and polysaccharide content was appr. 1 wt. %.

A whippable emulsion was prepared using the procedure described in Example 1. The emulsion had a viscosity of appr. 150 cP (100° F., 20 rpm, Helipath spindle B).

The emulsion was whipped using the procedure described in Example 1 to obtain a whipped topping with the properties described in Table 24.

TABLE 24

| | |
|---|---|
| pH | 7.4 |
| Water activity | 0.92 |
| Specific gravity | 0.82 |
| Viscosity freshly prepared ¹ | 3,000 cP |
| Viscosity after 12 hours ambient ¹ | 14,000 cP |

¹ 68° F., 10 rpm, Helipath spindle F

The whipped topping was not stable. The whipped topping failed the rosette test. The prepared whipped topping did not aerate to the target specific gravity of 0.35-0.55, resulting in a thin viscous emulsion. The whipped topping failed the flow test. Therefore the whipped topping was considered poor by exhibiting inadequate piping and decorating characteristics.

### Comparative Example C

Whipped chocolate syrup was prepared on the basis of the recipe shown in Table 25.

TABLE 25

| Ingredient | Wt. % |
|---|---|
| Granulated sucrose | 29.50 |
| Dutched cocoa 10/12 | 7.50 |
| Water | 46.00 |
| Soybean oil | 10.00 |
| Alpha cyclodextrin | 7.00 |

The whipped syrup was prepared by mixing sugar, cocoa and water having a temperature of 100° F. (38° C.) (at high speed in a Waring blender for 3 minutes. The end temperature of 23. Next the blend mixed for 5 minutes in a Hobart mixer at Speed 2. The cyclodextrin was mixed with the soybean oil as described in Example 1. Next, the oil/cyclodextin mixture was added to the sugar/cocoa/water mixture in the Hobart mixer and the combined ingredients were mixed for 5 minutes at Speed 2 (the mixture had too low a viscosity to be mixed at Speed 3). After minutes of stirring at Speed 2, the mixture had developed enough viscosity to be stirred at 3 for another 5 minutes. The whipped chocolate syrup so obtained had a temperature of 100° F. (38° C.) and a specific gravity of 0.54 g/ml.

The whipped chocolate syrup was piped through a large star tip into rosette. These rosettes were not sufficiently firm to be used as typical cake decorations. The ambient shelf-life of the whipped chocolate syrup was very limited. Changes to the texture and gas cell size and distribution were marked. Rosettes became rubbery and quickly lost their short texture.

### Comparative Example D

Comparative Example B was repeated except that this time the whipped chocolate syrup was prepared on the basis of the recipe shown in Table 26.

TABLE 26

| Ingredient | Wt. % |
|---|---|
| Granulated sucrose | 29.17 |
| Dutched cocoa 10/12 | 7.50 |
| Xanthan gum | 0.33 |
| Water | 46.00 |
| Soybean oil | 10.00 |
| Alpha cyclodextrin | 7.00 |

The xanthan gum was combined with the sugar, cocoa and water in the Waring blender before addition of the oil/cyclodextrin mixture. Again, the whipped chocolate syrup was piped through a large star tip into rosette. These rosettes were very rigid and did not have a sufficiently ‘short’ texture. The ambient shelf-life of these rosettes was very limited.

### Example 11

Whippable toppings were prepared on the basis of the recipes shown in Table 27.

TABLE 27

| | Wt. % | | | | |
|---|---|---|---|---|---|
| | 1 | 2 | 3 | 4 | 5 |
| Fat¹ | 21.16 | 21.16 | 21.16 | 21.16 | 21.18 |
| Lecithin² | 0.45 | 0.45 | 0.45 | 0.45 | 0.45 |
| Sugar | 5.85 | 4.86 | 3.67 | 2.48 | 1.19 |
| Corn starch³ | 1.82 | 1.82 | 1.82 | 1.82 | 1.82 |
| Hydroxypropylmethyl cellulose⁴ | 0.56 | 0.56 | 0.56 | 0.56 | 0.56 |
| Sodium carboxymethyl cellulose⁵ | 0.25 | 0.25 | 0.25 | 0.25 | 0.25 |
| Salt | 0.41 | 0.41 | 0.41 | 0.41 | 0.41 |
| High fructose corn syrup⁶ | 34.18 | 34.18 | 34.18 | 34.18 | 34.21 |
| Water | 28.97 | 28.77 | 29.96 | 31.15 | 32.37 |
| Alpha-cyclodextrin⁷ | 7.55 | 7.55 | 7.55 | 7.55 | 7.55 |
| Saccharides | 30.1 | 29.1 | 27.9 | 26.8 | 25.5 |
| Water | 37.7 | 38.7 | 39.9 | 41.1 | 42.3 |
| % Saccharides by water (w/w) | 80% | 75% | 70% | 65% | 60% |

¹Ultimate ® 92 (ex Cargill, USA), refined, bleached, hydrogenated and deodorized coconut oil; Iodine Value = 1.5, Mettler Dropping Point 94-100° F.
²Yelkin ® Gold Lecithin (ex ADM, USA)
³OptaMist ® 364 (ex JRS, USA)
⁴Methocel ® K99 (ex Dow, USA)
⁵Aqualon ® CMC-7HF (ex Ashland, USA)
⁶IsoClear ® (ex Cargill, USA) - Water content is 29%
⁷Cavamax ® W6 (ex Wacker Biosolutions, Germany) - Water content is 11% max.

All whippable emulsions were prepared from an identical slurry and an identical oil-lecithin blend, using an aqueous liquid to adjust the water and saccharide content of the final emulsion. These aqueous liquids represented about 9.3 wt. % of the final emulsion and had the following compositions (% by weight of the final emulsion):

TABLE 28

| | % by weight of emulsion | | | | |
|---|---|---|---|---|---|
| | 1 | 2 | 3 | 4 | 5 |
| Water | 4.63 | 5.62 | 6.81 | 8.00 | 9.20 |
| Sugar | 4.66 | 3.67 | 2.48 | 1.29 | 0.00 |

The whippable emulsions were prepared using the following procedure:
Oil was blended with lecithin and stored at 90° F.
Dry ingredients, except for cyclodextrin and part of the sugar, were mixed thoroughly with a whisk and sifted to ensure there were no lumps.
High fructose corn syrup was introduced into a dispersator, then the dry mix was added and mixed under high shear.
Water was heated to 200° F., then mixed into dry mix—high fructose corn syrup mixture with the dispersator.
Slurry was homogenized through a 2 stage piston homogenizer (1^{st} stage 4,500 psi, 2^{nd} stage 1,500 psi).
Homogenized slurry was placed in a heating vessel. Alpha-cyclodextrin was stirred into slurry. Slurry temperature at 140° F. was maintained.
Sugar was dissolved in water to prepare an aqueous liquid and introduced to the slurry. In the case of emulsion 5, only water was added to the slurry.
The oil-lecithin mixture was combined with the slurry in a mixing bowl of a Hobart mixer (Model N-50 table top mixer, Wire Whip D) and stirred at speed 1 until well mixed, about 1 minute. Mix speed was then increased to speed 2 for about 1 minute. Mixture was then whipped at speed 3 until aerated, about 5 minutes.

The emulsions so obtained were converted into a whipped topping. The properties of these whipped toppings so obtained are shown in Table 29.

TABLE 29

| | 1 | 2 | 3 | 4 | 5 |
|---|---|---|---|---|---|
| pH | 5.89 | 5.83 | 5.89 | 5.84 | 5.99 |
| Water Activity | 0.93 | 0.93 | 0.92 | 0.92 | 0.91 |
| Specific Gravity | 0.52 | 0.52 | 0.43 | 0.41 | 0.48 |
| Viscosity freshly prepared¹ | 147,000 | 251,000 | 215,000 | 148,000 | 175,000 |
| Viscosity 12 hours ambient¹ | 226,000 | 239,000 | 250,000 | 299,000 | 289,000 |

¹68° F., 10 rpm, Helipath spindle F

The whipped toppings showed excellent ambient stability. When the whipped toppings were piped through a star tip into rosettes, resulting rosettes possessed a full body and sharp ridges with a glossy appearance. Rosettes stored at ambient and elevated temperatures (100° F.) over a 12 hour period maintained their shape and appearance. The whipped toppings were sufficiently viscous and stable to pass the flow test, whereby all of the whipped topping remained within a funnel suspended over a collection container stored at ambient temperature over a 12 hour period.

1. An aeratable or aerated oil-in-water emulsion comprising a continuous aqueous phase and a dispersed oil phase, said emulsion comprising:
(a) 15-45 wt. % water;
(b) 4-50 wt. % oil;
(c) 3-12 wt. % of cyclodextrin selected from alpha-cyclodextrin, beta-cyclodextrin and combinations thereof;
(d) 20-60 wt. % of saccharides selected from monosaccharides, disaccharides, non-cyclic oligosaccharides, sugar alcohols and combinations thereof;
(e) 1-20 wt. % of polysaccharides;
(f) 0-30 wt. % of other edible ingredients;
wherein the saccharides are contained in the emulsion in a concentration of at least 60% by weight of water and wherein the polysaccharides are contained in the emulsion in a concentration at least 2% by weight of water.

2. The emulsion according to claim 1, wherein the polysaccharides comprise 1-30% by weight of water of polysaccharide component selected from polysaccharide filler, polysaccharide viscosifier and combinations thereof, said polysaccharide filler being selected from hydrolysed starch, starch, inulin and combinations thereof.

3. The emulsion according to claim 2, wherein the polysaccharides comprise 1-25% by weight of water of the polysaccharide filler.

4. The emulsion according to claim 3, wherein the polysaccharides comprise at least 4% by weight of water of the polysaccharide filler.

5. The emulsion according to claim 2, wherein the polysaccharide filler is hydrolysed starch.

6. The emulsion according to claim 5, wherein the hydrolysed starch has a dextrose equivalent (DE) in the range of 1 to 20.

7. The emulsion according to claim 5, wherein the hydrolysed starch has a dextrose equivalent (DE) in the range of 5 to 18.

8. The emulsion according to claim 2, wherein the polysaccharides comprise 0.1-10% by weight of water of polysaccharide viscosifier.

9. The emulsion according to claim 8, wherein the polysaccharides comprise not more than 15% by weight of water of the polysaccharide filler.

10. The emulsion according to claim 8, wherein the polysaccharide viscosifier is selected from natural gums, pectins, carboxymethyl cellulose, cellulose fibres and combinations thereof.

11. The emulsion according to claim 10, wherein the polysaccharide viscosifier is natural gum.

12. The emulsion according to claim 11, wherein the natural gum is a polyelectric natural gum selected from gum arabic, gellan gum and combinations thereof.

13. The emulsion according to claim 11, wherein the natural gum is locust bean gum.

14. The emulsion according to claim 10, wherein the polysaccharide viscosifier is pectin.

15. The emulsion according to claim 10, wherein the polysaccharide viscosifier is carboxymethyl cellulose.

16. The emulsion according claim 10, wherein the polysaccharide viscosifier is cellulose fibre.

17. The emulsion according to claim 16, wherein the cellulose fibre originates from citrus fruit or sugar beet.

18. The emulsion according to claim 1, wherein the cyclodextrin is alpha-cyclodextrin.

19. The emulsion according to claim 1, wherein the non-aerated emulsion has a water activity of less than 0.95.

20. A foodstuff comprising 1-50 wt. % of the aerated emulsion according to claim 1.

21. The foodstuff according to claim 20, wherein the foodstuff is a product selected from cake, pie, custard, non-frozen dessert, frozen dessert, ice cream, fruit pieces and confectionary.

22. A method of preparing a foodstuff according to claim 21, comprising heating the foodstuff comprising the aerated emulsion to a temperature in excess of 60° C. (140° F.) for at least 1 minute.
